(19) United States
(12) Patent Application Publication
(10) Pub. No.: US 2010/0090057 A1
(43) Pub. Date: Apr. 15, 2010

(54) Conveyance

(76) Inventor: Regina B. Liska, Apopka, FL (US)

Correspondence Address: P. Jeff Martin of The McGougan Law Firm, LLC, 1180 Hwy. 17 N., Suite 2, P.O. Box 250, Little River, SC, 29566, US

(21) Appl. No.: 12/287,963

(22) Filed: Oct. 15, 2008

(51) Int. Cl. B64C 39/00; H01S 3/00; G06F 17/00; G01C 21/00

(52) U.S. Cl. 244/62; 372/109; 701/3; 701/213

(57) ABSTRACT

An apparatus which exhibits properties allowing it to levitate and travel utilizing magnetic energy.

### RELATED APPLICATIONS

There are no previously filed, nor currently any co-pending applications, anywhere in the world.

### BACKGROUND OF THE INVENTION

1. Field of the Invention

This application discloses claims and embodiments generally related to a mode of transportation, and more particularly, a conveyance exhibiting properties allowing it to levitate and travel utilizing magnetic energy.

2. Description of the Related Art

It is desirable to have modes of transportation that shorten travel time while also saving-on the expense(s) of fuel. But, it is also important that fuel is conserved so as not to pollute the environment. Thus, it is advantageous to have an apparatus or device having the elements and features disclosed herein, whereby an alternative fuel source is generated that is consumed in an environmentally friendly manner.

Several products and inventions have been proposed in order to achieve these goals. The art is filled with attempts at alternative fuel sources, alternative engine configurations, and myriad components for creating fuel efficiencies or scrubbing the pollutants from the exhaust generated by combustion engines and the like. However, the art does not appear to disclose the combination of elements and features disclosed herein.

This application presents claims and embodiments that fulfill a need or needs not yet satisfied by the products and inventions previously or presently available. In particular, the claims and embodiments disclosed herein describe a conveyance that generates through translation a fuel source that does not pollute the environment, and in doing so provides an unanticipated and nonobvious combination of features distinguished from the products and inventions preexisting in the art. The applicant is unaware of any product, disclosure or reference that discloses the features of the claims and embodiments disclosed herein, and as more fully described below.

Accordingly, a need has arisen for an alternative mode of travel, and more particularly, an apparatus which exhibits properties allowing it to levitate and travel utilizing magnetic energy in a manner which is quick, easy, and efficient. The development of the conveyance fulfills this need.

### SUMMARY OF THE INVENTION

Therefore, it is an object of the present invention to provide an alternative means for travel.

It is another object of the present invention to provide a conveyance generally comprising a body fabricated from an alloy.

It is another object of the present invention to provide a disc-shaped object capable of flight.

It is another object of the present invention to provide a means for generating electromagnetic pulses between the plurality of magnets to generate usable electric fluid.

It is yet another object of the present invention to provide a means for generating a vacuum, the vacuum further generating low pressure at an opposite end of the conveyance allowing atmospheric pressure to exert force and thrust upon the opposite end and propelling the conveyance in the direction of travel.

In accordance with one embodiment, a conveyance comprising a body comprising AlNiCo; a rheostat; a plurality of magnets; means for generating electromagnetic pulses between the plurality of magnets to generate usable electric fluid; means for generating voltage; means for generating cathode rays; means for generating anode rays; means for aligning the cathode rays and the anode rays to intersect at a 45 degree angle relative to one another; means for switching between the polarity of the conveyance and the polarity generated by Earth, switching means initiating levitation of the conveyance; and wherein high voltage passed through rheostat in combination with the intersection of the cathode rays and the anode rays generates a vacuum at one end of the conveyance aligned in the direction of travel of the conveyance, the vacuum further generating low pressure at an opposite end of the conveyance allowing atmospheric pressure to exert force and thrust upon the opposite end and propelling the conveyance in the direction of travel. The conveyance may further comprise a positioning system. The conveyance may also further comprise a plurality of lasers interoperable with the positioning system.

It is also envisioned that the conveyance may further comprise a computer comprising a central processing unit (cpu), the computer having installed on storage media executable instructions for receiving and interpreting data generated by the positioning system and/or the plurality of lasers.

The plurality of lasers are installed at the center of the conveyance to enhance steering and maneuvering of the conveyance.

The conveyance may further comprise means for maintaining stable atmospheric pressure at the base of the conveyance and generating decompression at the top of the conveyance, the difference in atmospheric pressure generating ascent of the conveyance upon request.

It is envisioned that the AlNiCo comprises 8% to 12% aluminium; 15% to 26% nickel; and 5% to 24% cobalt. The AlNiCo may further comprise 38% to 72% of at least one of the members selected from group consisting of iron, copper and titanium.

It is further envisioned that the AlNiCo may comprise 8% to 12% aluminium; 15% to 26% nickel; 5% to 24% cobalt; 0% to 6% copper; 0% to 1% titanium; and the remainder comprising iron.

The use of the present invention allows in a manner which is quick, easy, and efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a conveyance, according to the preferred embodiment of the present invention;

FIG. 2 is a cross-sectional view of the conveyance taken along the line II-II of FIG. 1;

FIG. 3 is a cross-sectional view of the conveyance taken along the line III-III of FIG. 1; and

FIG. 4 is a block diagram of the conveyance illustrating means by which conveyance is enabled to travel, according to one embodiment of the present invention.

### DESCRIPTION OF THE PREFERRED EMBODIMENT

### Detailed Description of the Figures

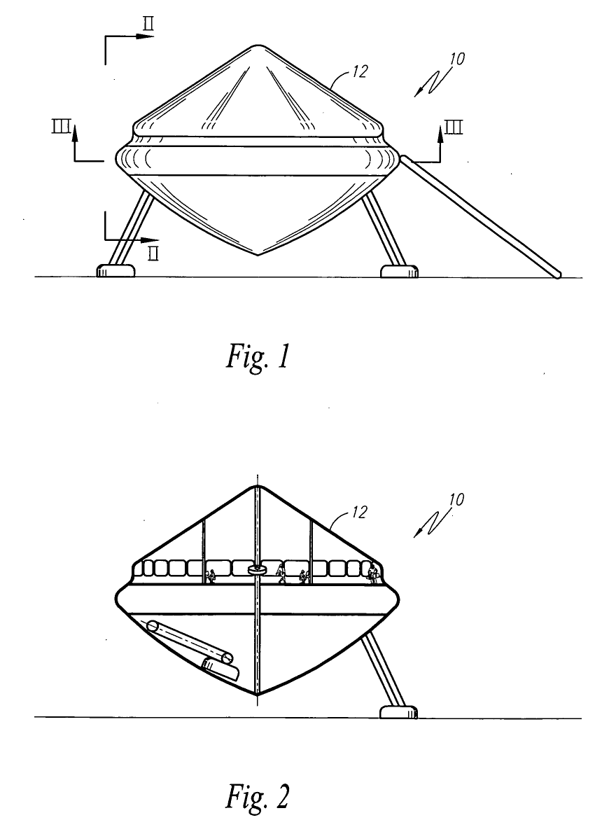

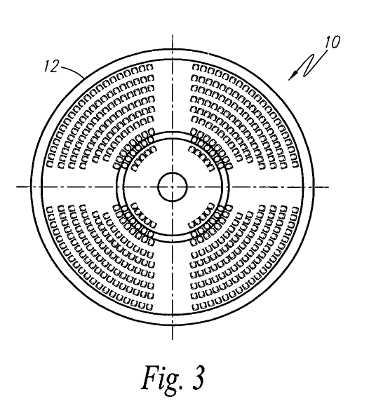

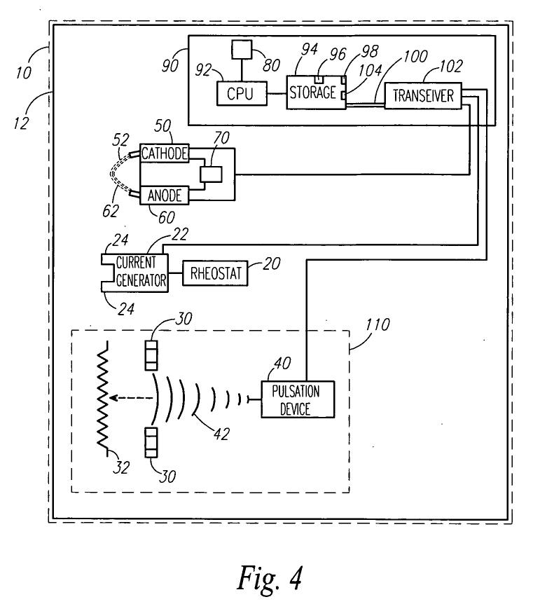

With reference to the figures, specifically FIG. 1 through FIG. 4, a conveyance is disclosed and generally denoted by the reference character 10. A conveyance may include any of several modes of transportation, including automobiles, airplanes, gliders, space shuttles or other similar devices or apparatuses. In the description and the accompanying figures, a disc-shaped object capable of flight is depicted as but one possible embodiment encompassed by the description and claims set forth in this application.

Referring now to FIG. 1 through FIG. 4, one embodiment disclosed describes a conveyance 10 is disclosed, the conveyance generally comprising a body 12 fabricated from an alloy generally denoted as “AlNiCo”, “alnico” or other similar variations. The term “AlNiCo” and its substitutes represent the combined names and chemical symbols of aluminium (Al), nickel (Ni) and cobalt (Co) in various percentages. AlNiCo may also include quantifiable amounts of copper, titanium and iron separately or in various combinations. Generally, AlNiCo comprises 8% to 12% aluminium, 15% to 26% nickel, and 5% to 24% cobalt as the basis for the alloy. It is envisioned that AlNiCo may further comprise 0% to 6% copper, 0% to 1% titanium, and the remainder comprising iron. AlNiCo is a suitable material for the body of the conveyance as AlNiCo magnets may produce magnetic field strength as high as 1500 Gauss (0.15 Tesla), which is approximately equivalent to 3000 times the strength of the Earth's magnetic field. Because of AlNiCo's properties, generating a powerful magnetic adherence, it is possible to induce a magnetic induction relative to Earth and cause the conveyance to levitate and/or move in various directions upon command. The body of the conveyance 10 may be fabricated in a variety of forms, though it is envisioned that a disc-shape having the proportions of 1.1618 is optimal.

The conveyance 10 also includes a rheostat 20 (often a two-terminal variable resistor) for controlling the high voltage and/or current generated by a voltage or current generating device 22 or combination of devices. It is envisioned that the voltage or current generating device(s) 22 may comprise one or more laser technology devices 24, although other suitable substitutes are also envisioned. The rheostat 20 is variably adjustable to increase or decrease the output (voltage or current). Increasing or decreasing the voltage impacts the intensity of the vacuum generated (as discussed below), as a directly proportional relationship exists so that increases in voltage increase the intensity of the vacuum and decreases in voltage decrease the intensity of the vacuum.

The conveyance also includes a plurality of magnets 30 systemically arranged or configured so that a pulsation device 40 generating electromagnetic pulses 42 may be integrated in such a way that the electromagnetic pulses 42 are generated between the magnets 30. In generating the pulses 42 between the magnets 30, a usable electric field 32 is generated, the electric field 32 utilized by the conveyance 10 to cause levitation and/or movement of the conveyance 10 upon request.

The conveyance 10 also includes a cathode 50 and/or an anode 60 for generating cathode rays 52 and/or anode rays 62, respectively. The cathode and/or anode devices 50, 60 may comprise a variety of devices, apparatuses and combinations thereof to generate the appropriate cathode rays 52 and anode rays 62. It is further envisioned that an alignment device 70 is utilized for aligning the resulting cathode rays 52 and anode rays 62 in a manner that the rays intersect with one another at a 45 degree angle, although the intersecting of the rays 52, 62 is not necessarily limited strictly to the 45 degree angle. In combination with the high voltage generated, and which is controlled by the rheostat 20, the cathode rays 52 and the anode rays 62 intersect to form a 45 degree angle, thereby generating a vacuum through which travel may be achieved. The vacuum is generated in the desired direction of travel, usually at an “end” or terminal area of the conveyance 10. In such an arrangement, low pressure is generated at the opposite “end”. The low pressure at the opposing end or area permits the atmospheric pressure to exert sufficient force upon the low pressure end and provide a powerful thrust and propel the conveyance toward the desired direction of travel.

The electric fluid 32 generated by the pulses 42 passed between the magnets 30 (switching means 110), as set forth above generates a switch between the magnetic polarity of the conveyance 10 and the magnetic polarity of Earth. Via the switching or exchange, levitation of the conveyance 10 is initiated. The levitation corresponds with the natural flow of the atmospheric pressure present, which permits the conveyance 10 to travel at high rates of speed. To control the pace and path that the conveyance 10 may travel, the conveyance 10 may further include laser technology 24 (as indicated previously) in combination with the rheostat 20 and further in combination with a positioning system 80, such as a global positioning system (GPS) or other suitable alternative. Through this combination, the conveyance 10 may be manually or automatically controlled solely or partially through an integrated computer 90. The computer 90 may include a central processing unit (cpu) 92 and storage media 94, with executable instructions 96 stored thereon and accessible for receiving and processing information or data 98 to aid or fully control the traveling characteristics and destination(s) of the conveyance 10 as input. More specifically, the storage media 94 is installed with executable instructions 96 for receiving and interpreting data 98 generated by the positioning system and/or the plurality of lasers 24. A communication interface 100 may be operatively coupled with a wireless transceiver device 102 for receiving and transmitting information or data 104 to storage media for allowing other various functional capabilities such as communication and as an auxiliary aid to controlling the traveling characteristics and destination(s) of the conveyance 10.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A conveyance comprising:
a body comprising AlNiCo;
a rheostat;
a plurality of magnets;
means for generating electromagnetic pulses between the plurality of magnets to generate usable electric fluid;
means for generating voltage;
means for generating cathode rays;
means for generating anode rays;
means for aligning the cathode rays and the anode rays to intersect at a 45 degree angle relative to one another; and
means for switching between the polarity of the conveyance and the polarity generated by Earth, switching means initiating levitation of the conveyance; and wherein high voltage passed through rheostat in combination with the intersection of the cathode rays and the anode rays generates a vacuum at one end of the conveyance aligned in the direction of travel of the conveyance, the vacuum further generating low pressure at an opposite end of the conveyance allowing atmospheric pressure to exert force and thrust upon the opposite end and propelling the conveyance in the direction of travel.

2. The conveyance of claim 1 further comprising a positioning system.

3. The conveyance of claim 2 further comprising a plurality of lasers interoperable with the positioning system.

4. The conveyance of claim 3 further comprising a computer comprising a central processing unit (cpu), the computer having a storage media on which is installed executable instructions for receiving and interpreting data generated by the positioning system and/or the plurality of lasers.

5. The conveyance of claim 2, wherein the plurality of lasers are installed at the center of the conveyance to enhance steering and maneuvering of the conveyance.

6. The conveyance of claim 1 further comprising means for maintaining stable atmospheric pressure at a base of the conveyance and generating decompression at a top of the conveyance, the difference in atmospheric pressure generating ascent of the conveyance upon request.

7. The conveyance of claim 1, wherein the AlNiCo comprises:
8% to 12% aluminium;
15% to 26% nickel; and
5% to 24% cobalt.

8. The conveyance of claim 7, wherein the AlNiCo further comprises 38% to 72% of at least one of the members selected from group consisting of iron, copper and titanium.

9. The conveyance of claim 1, wherein the AlNiCo comprises:
8% to 12% aluminium;
15% to 26% nickel;
5% to 24% cobalt;
0% to 6% copper;
0% to 1% titanium; and
a remainder comprising iron.

10. A conveyance comprising:
a body comprising AlNiCo, the body having a disc shape with proportion of 1.1618;
a positioning system;
a rheostat;
a plurality of magnets;
means for generating electromagnetic pulses between the plurality of magnets to generate usable electric fluid;
means for generating voltage;
means for generating cathode rays;
means for generating anode rays;
means for aligning the cathode rays and the anode rays to intersect at a 45 degree angle relative to one another;
means for switching between the polarity of the conveyance and the polarity generated by Earth, switching means initiating levitation of the conveyance; and
wherein high voltage passed through rheostat in combination with the intersection of the cathode rays and the anode rays generates a vacuum at one end of the conveyance aligned in a direction of travel of the conveyance, the vacuum further generating low pressure at an opposite end of the conveyance allowing atmospheric pressure to exert force and thrust upon the opposite end and propelling the conveyance in the direction of travel.

11. The conveyance of claim 10 further comprising a global positioning system.

12. The conveyance of claim 11 further comprising a plurality of lasers interoperable with the positioning system.

13. The conveyance of claim 12 further comprising a computer comprising a central processing unit (cpu), the computer having a storage media on which is installed executable instructions for receiving and interpreting data generated by the positioning system and/or the plurality of lasers.

14. The conveyance of claim 12, wherein the plurality of lasers are installed at a center of the conveyance to enhance steering and maneuvering of the conveyance.

15. The conveyance of claim 10 further comprising means for maintaining stable atmospheric pressure at a base of the conveyance and generating decompression at a top of the conveyance, the difference in atmospheric pressure generating ascent of the conveyance upon request.

16. The conveyance of claim 11, wherein the AlNiCo comprises:
8% to 12% aluminium;
15% to 26% nickel; and
5% to 24% cobalt.

17. The conveyance of claim 16, wherein the AlNiCo further comprises 38% to 72% of at least one of the members selected from group consisting of iron, copper and titanium.

18. The conveyance of claim 10, wherein the AlNiCo comprises:
8% to 12% aluminium;
15% to 26% nickel;
5% to 24% cobalt;
0% to 6% copper;
0% to 1% titanium; and
a remainder comprising iron.
